(19) United States
(12) Patent Application Publication
(10) Pub. No.: US 2007/0030254 A1
(43) Pub. Date: Feb. 8, 2007

(54) Integration of touch sensors with directly mounted electronic components

(76) Inventors: Michael J. Robrecht, Shorewood, WI (US); George F. Jambor, Slinger, WI (US); Jonathan P. Maag, New Berlin, WI (US)

Correspondence Address: 3M INNOVATIVE PROPERTIES COMPANY, PO BOX 33427, ST. PAUL, MN, 55133-3427, US

(21) Appl. No.: 11/377,976

(22) Filed: Mar. 17, 2006

Related U.S. Application Data
(60) Provisional application No. 60/701,283, filed on Jul. 21, 2005.

(51) Int. Cl. G09G 5/00

(52) U.S. Cl. 345/173

(57) ABSTRACT

Disclosed is a touch sensor assembly that includes a touch sensor overlay and one or more circuit boards held in place by a frame. The touch sensor overlay includes a plurality of touch sensitive elements and a plurality of conductors connected to the touch sensitive elements arranged on the touch sensor periphery. The one or more circuit boards are electrically connected to the plurality of conductors on the touch sensor periphery. The circuit boards include circuitry for conditioning signals communicated by the touch sensitive elements due to a touch on the touch sensor overlay. Also disclosed are methods of bonding circuit boards to a touch sensor overlay.

### CROSS REFERENCE TO RELATED APPLICATION

This application claims the benefit of U.S. Provisional Patent Application No. 60/701,283, filed Jul. 21, 2005.

The present application relates to touch sensor overlays incorporating integrated electronic components and methods of integrating electronic components with touch sensor overlays.

### BACKGROUND

Touch sensors can provide a useful and intuitive way to interact with computer systems, particularly those that include a display. In many applications, the touch sensor is provided in the form of a transparent overlay that is disposed over the display. Touch sensor overlays typically have signal lines that communicate signals obtained by the touch sensitive elements of the touch sensor to controller electronics that use the signals to determine information related to the touch event, such as touch position.

### SUMMARY OF THE INVENTION

The present invention provides a touch sensor assembly that includes a touch sensor overlay and one or more circuit boards held in place by a frame. The touch sensor overlay includes a plurality of touch sensitive elements and a plurality of conductors connected to the touch sensitive elements arranged on the touch sensor periphery. The one or more circuit boards are electrically connected to the plurality of conductors on the touch sensor periphery. The circuit boards include circuitry for conditioning signals communicated by the touch sensitive elements due to a touch on the touch sensor overlay.

In some embodiments, the construction of the touch sensor overlay can include one or more flexible films laminated to a rigid substrate, where the plurality of touch sensitive elements and the plurality of conductors being formed on the flexible film. In certain embodiments, it may be desirable to match the coefficient of thermal expansion of the frame to the materials of the touch sensor, for example by providing a frame having a coefficient of thermal expansion that falls within a range bounded by the coefficients of thermal expansion of the one or more flexible films and the rigid substrate. In some embodiments, the frame can include self-fixturing features, for example for controlling a spacing between the frame and a part of the touch sensor, the frame and the one or more circuit boards, and/or the one or more circuit boards and a part of the touch sensor.

The present invention also provides methods of bonding electronics to a touch sensitive overlay. In the methods, a touch sensor is provided that includes a plurality of touch sensitive elements and a plurality of conductors connected to the touch sensitive elements arranged on the touch sensor periphery. Further provided are one or more circuit boards that include circuitry for conditioning signals communicated by the touch sensitive elements due to a touch on the touch sensor, each circuit board having a plurality of conductive contact areas. The method includes dispensing an insulative adhesive on the touch sensor periphery and forming apertures in the adhesive to individually expose the plurality of conductors on the touch sensor. A conductive material is placed on the plurality of conductors, and the one or more circuit boards are positioned on the touch sensor periphery so that the conductive material electrically connects each of the conductive contact areas to one of the plurality of conductors and the adhesive bonds the circuit board to the touch sensor.

In some embodiments, the methods can include using a frame to aid in the positioning of the one or more circuit boards, and/or to control a spacing between the frame and the sensor, between the circuit boards and the sensor, or between the frame and the circuit boards.

The above summary is not intended to describe each embodiment or every implementation of the present disclosure. Advantages and attainments, together with a more complete understanding of the invention, will become apparent and appreciated by referring to the following detailed description and claims taken in conjunction with the accompanying drawing.

### BRIEF DESCRIPTION OF THE DRAWING

The invention may be more completely understood in consideration of the following detailed description of various embodiments of the invention in connection with the accompanying drawings, in which:

FIG. 1 is a partial schematic side view of a touch sensor with directly mounted electronic components according to the present disclosure;

FIG. 2(a) is a partial schematic plan view of a touch sensor with a dispensed adhesive and conductive material prior to placing electronic components;

FIG. 2(b) is a partial schematic plan view of a touch sensor with a dispensed adhesive and conductive material after bonding with electronic components and a frame (not shown);

FIG. 3 is a partial schematic side view of a circuit board bonded to a touch sensor according to the present disclosure;

FIG. 4 is an exploded schematic view of a touch sensor and a frame useful in embodiments of the present invention;

FIG. 5(a) is an enlarged schematic view of a portion of a frame such as shown in FIG. 4;

FIG. 5(b) is a cross-sectional schematic view of the frame shown in FIG. 5(a);

FIG. 5(c) is a cross-sectional schematic perspective view of components that may be included in a frame such as shown in FIG. 5(a);

FIG. 6(a) is a schematic plan view of a touch sensor construction useful in some embodiments of the present invention; and

FIG. 6(b) is a schematic side view of the touch sensor construction shown in FIG. 6(a).

### DETAILED DESCRIPTION

The present disclosure relates to integrated touch sensor assemblies that include a touch sensor and electronic components directly mounted on the touch sensor. Such touch sensor assemblies may be particularly useful in applications where it desirable to use circuitry to condition the touch signals prior to communication with the controller electronics.

The touch screens used in most applications employ a flexible tail connected to traces on a sensor and to a circuit board. This approach works well in applications where the connection count is limited to 4, 5 or even 8 leads, but becomes unmanageable with grid configurations where lead counts approaching 50 to 100 or more are being considered. High lead counts can exist for matrix-type touch sensors, for example, that utilize a plurality of conductive sensing elements and where the design calls for a low ratio of sensing elements to lead lines (for example one-to-one). Such touch sensors may be suitably used in projected capacitive touch systems, inductive pen touch systems, and the like, including those used and proposed for use in applications that require high resolution pen and/or touch input such as tablet PCs. Examples include those disclosed in US 2004/0155871, US 2004/0095333, and US 2005/0083307, which documents are incorporated by reference herein.

One way to solve the high lead count issue is to mount one or more circuit boards along one or more edges of the sensor, the circuit boards including electronics that condition the signals and reduce the trace count. The present invention provides methods and materials to solve the technical problems of attaching these electronics, including those described below.

A molded frame can be used to hold the circuit boards, coils and tails relative to each other. A prefabricated assembly of these items can then be bonded to the sensor as a unified subassembly. The subassembly can act as its own fixture, eliminating the need for secondary fixturing. Integration of sensors and electronics through such subassemblies can also allow for reduced handling of the sensor, reducing potential damage and contamination.

The frame can be made of material whose coefficient of thermal expansion (CTE) is matched, or nearly so, to one or more of the materials of the sensor construction, typically glass and one or more flexible film layers such as polyethylene terapthalate (PET). CTE matching can help reduce the possibility of stress cracking the electrical and dielectric connection during thermal cycling experienced during storage, shipping and use of the sensor. For sensors that utilize one or more PET films laminated to glass, an exemplary frame material has a CTE between that of glass (CTE about 0.46×10⁵/° F.) and PET (CTE about 1.0×10⁵/° F.). Candidate materials include liquid crystal polymer (LCP) with about 20% to 40% glass fill, and about 30% to 50% glass filled polycarbonate (PC). To achieve a desirable CTE between that of glass and PET, the glass filled LCP requires relatively little glass filler content, and is sufficiently low in viscosity during molding conditions to allow for creating desirably fine details and small wall thicknesses that may be difficult to achieve with other materials.

Current integration processes involve dispensing of silver epoxy, attaching a circuit board, curing the epoxy, and dispensing and curing a dielectric. The present invention provides for dispensing a conductive paste, attaching a circuit board, dispensing a dielectric, and then curing both the silver and the dielectric at the same time. This approach can greatly reduce the curing time and handling steps. To accomplish this, the conductive paste and dielectric materials are preferably selected to limit mixing of the materials at their boundaries. In an alternative embodiment, a z-axis conductive adhesive can be used in place of using separate conductive paste and dielectric materials.

In another embodiment of the present invention, the dispensed dielectric adhesive can be replaced with a cut and laminated mounting adhesive such as a pressure sensitive adhesive (PSA). Advantages include eliminating the need for a fixture to hold the subassembly while the dielectric adhesive is curing, eliminating the need for adhesive dispensing, which can reduce assembly time and potential for contamination due to spillage.

In another embodiment, a non-curing silver paste can be used to electrically connect the sensor leads with the circuit board. This solution can eliminate a curing step, improve utilization of the silver compound (i.e., no unused epoxy that sets up in the dispenser and has to be discarded), and can eliminate potential bond failure due to thermal or mechanical stress during processing or end use.

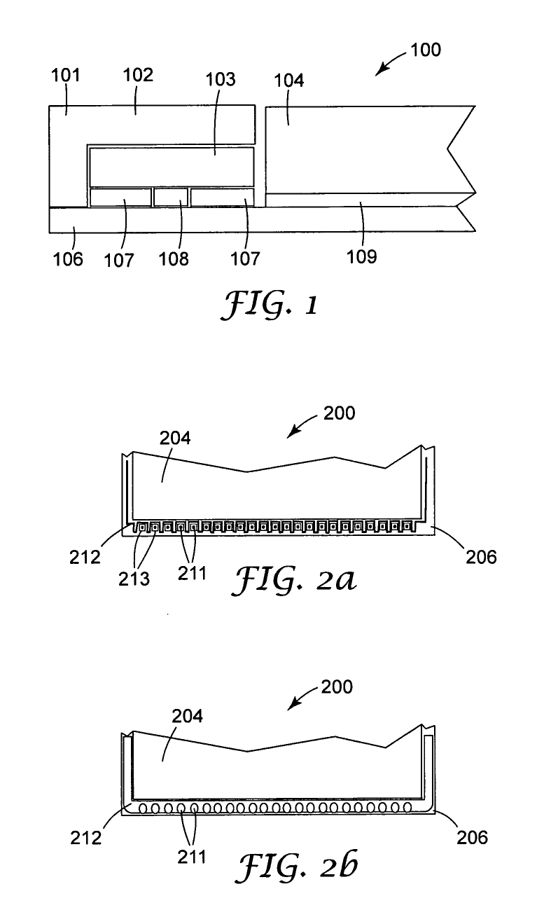

FIG. 1 shows a schematic cross section of a portion an integration structure according to one embodiment of the present invention. The integration structure 100 includes a glass backing panel 104 that is bonded to a sensor substrate 106 using an optical adhesive 109. An injection molded frame 101 and a pre-assembled printed circuit board (PCB) 103 are attached to the sensor substrate 106 with a pressure sensitive adhesive 107. Apertures are formed in the adhesive 107 to allow a conductive material 108 placed therein to form an electrical contact between conductors on the sensor and the conductors on the PCB. Alternatively, a z-axis conductive adhesive can be used, for example covering the entire bonding area with the z-axis conductive adhesive, which can ensure electrical connection between aligned sensor and PCB conductors while maintaining electrical isolation between adjacent sensor or PCB conductors.

FIGS. 2(a) and 2(b) show a schematic plan view of a portion of an integration structure according to an embodiment of the present invention. One particular edge of the sensor 200 is shown prior to the assembly of the PCB and frame sub-assembly (not shown). A glass substrate 204 is adhered to the sensor substrate 206. The sensor substrate includes conductive bonding areas 213, which may be made of any suitable conductive material such as indium tin oxide (ITO) or other transparent conductive oxide, silver or carbon filled polymer thick film ink, or the like. Conductive material 211 can be patterned or otherwise discretely placed by dispensing, printing or other suitable method onto each of the conductive bonding areas 213. A dielectric adhesive material 212 can be patterned or dispensed onto the substrate perimeter in a pattern such as that indicated in FIG. 2(a), preferably so that the adhesive will provide both a subsequent mechanical bond to the PCB and frame sub-assembly as well as act as an insulator between the conductive material locations.

FIG. 2(b) shows the construction of FIG. 2(a) after the dielectric adhesive 212 and conductive material 211 have spread out upon assembly with the PCB and frame sub-assembly (not shown). These materials, being substantially liquid in character, but of sufficiently high viscosity such that they stay substantially in place, will spread out due to the compression of the PCB and frame sub-assembly when placed down into position on the perimeter of the sensor 206. A series of standoffs or protrusions from the frame can be used to determine a separation gap between the circuit board and the sensor to accommodate a proper thickness of dielectric adhesive and conductive material between the various components. The volume of the materials 211 and 212 and the dispense pattern of the dielectric adhesive 212 can be selected so that the controlled gap between the PCB and frame sub-assembly and the sensor 206 will allow the material to spread over substantially the entire area of the sensor perimeter, with little or no flow beyond the edges of the sensor 200. The materials 211 and 212 are preferably selected to substantially resist mixing, thereby resulting in more reliable conductive connection between the sensor and PCB, as well as electrical isolation between adjacent conductive bonding areas.

FIG. 3 shows a schematic cross-section along the edge of a digitizer assembly showing a plastic frame 301 and PCB 303 assembled to the sensor substrate 306. The PCB has a plurality of isolated conductive contact areas 313 that are to be electrically connected discretely to a plurality of isolated conductive contact areas 310 on the sensor. The electrical connections between the conductive contact areas are achieved using a conductive material 311 placed in each of the plurality of locations prior to assembly. An adhesive 312 placed in between each of the plurality of conductive contact areas serves as the mechanical bond holding the structure together. This adhesive 312 also serves as an electrical insulator between the conductive contact areas to ensure isolation. Adhesive 312 can be any suitable material such as a pressure sensitive film adhesive, an epoxy, a urethane, or any other suitable liquid or film adhesive.

The present invention includes reducing the stress to the bond area between the sensor and PCBs. This can be accomplished by selection of the frame material. The materials utilized in the overall construction, such as PET for the sensor substrate, glass, and FR4 circuit board material, all have different coefficients of thermal expansion, and which are preferably taken into consideration when selecting the frame material. Table 1 shows the CTE values for various materials typical for sensor constructions, and for various candidate frame materials.

TABLE 1
Coefficient of Thermal Expansion (CTE) of Selected Materials

| Material | CTE (×10⁵/° F.) |
|---|---|
| PET | 1.0 |
| Glass | 0.46 |
| FR4 PCB | 0.89 |
| Polycarbonate | 4 |
| Acrylic | 4 |
| Glass filled LCP | 0.9 to 7 |
| Glass filled Polycarbonate | 1.2 |

As can be seen from Table 1, the materials to be bonded, that is the PET sensor substrate and the FR4 PCB, both have nearly the same CTE. It is advantageous in order to reduce linear stresses to match the CTEs of the various materials. In light of this, selecting a plastic material for the frame that is close to that of the PET sensor and the FR4 PCB can reduce thermal expansion and contraction stresses. In particular, the glass filled polycarbonate and a properly chosen formulation of filled LCP can be suitable materials for this construction. The CTE of the LCP material can be tailored to a specific value by changing the glass filling content. Suitable LCP materials include the liquid crystal polyester and amide copolymer available under the trade designation Vectra B® from Goodfellow Corporation.

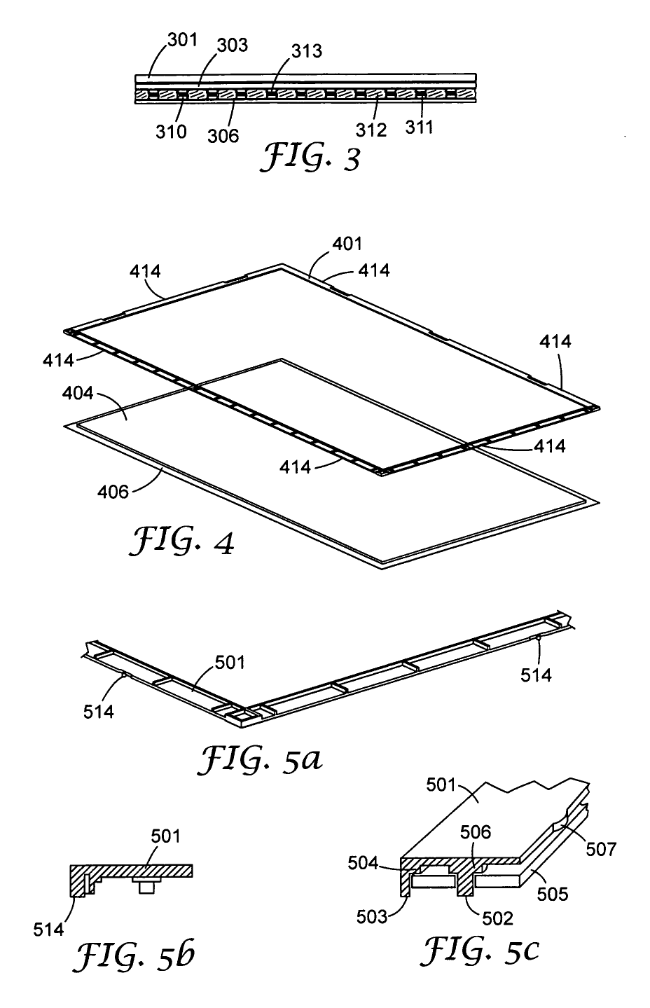

FIG. 4 shows a schematic exploded isometric view of a plastic injection molded frame 401 and a sensor sub-assembly that includes a glass backer 404 and a sensor substrate 406. Also depicted are alignment tabs 414 that are used to align the frame and PCB sub-assembly to the sensor sub-assembly such that the frame acts as the assembly fixture, eliminating the need for extra manufacturing fixturing to achieve this assembly step. This tabs 414 can be left on the completed assembly, or can be fashioned to be easily removable by breaking them off after the assembly has been completed. The tabs may be molded in such a way as to provide a preferred breakage point to facilitate their removal.

FIG. 5(a) shows a magnified schematic isometric view of alignment tabs 514 on a plastic frame 501. The plastic tabs 514 extend beyond the plane of the plastic frame 501 to act as edge registration stops for the PET substrate edges of the sensor sub-assembly. FIG. 5(b) schematically shows a cross section of the frame 501, depicting one of the alignment tabs 514, which extends below the bottom surface and can be utilized as an edge stop for the PET substrate to align the PET substrate to the frame.

The frame 501 can include self-fixturing features, for example to predetermine location and spacings for various elements of the assembly as shown in FIGS. 5(b) and 5(c). FIG. 5(b) shows a breakaway tab or pin 514 for locating the frame-and-board subassembly relative to the sensor along the perimeter of the sensor (sensor not shown, refer to FIG. 1). As shown in FIG. 5(c), a pin 502 can be provided that protrudes past the front surface of the circuit board 505 to create a controlled gap between the circuit board 505 and sensor surface (not shown, but may be positioned to engage pin 502). The controlled gap provides room for the circuit boards, and can also establish a proper thickness for the mounting adhesive and conductive material disposed therein. A perimeter wall 503 can be used to capture dispensed material that might otherwise flow off the sensor, and can include a ledge portion 504 to help support the circuit board 505. The inclusion of pins like pin 502 can also be used to maintain a predetermined gap between the frame 501 and the sensor to control the dispensed mounting adhesive thickness in areas where a circuit board is not present. A shoulder 506 provided at the base of pin 502 can work in conjunction with ledge 504 to establish a gap between the body of frame 501 and the circuit board 505 for protecting components mounted on the board. A protrusion 507 in the frame 501 can also be provided to create a controlled gap between the inside edges of the frame and the perimeter edge of the sensor glass (see FIG. 1).

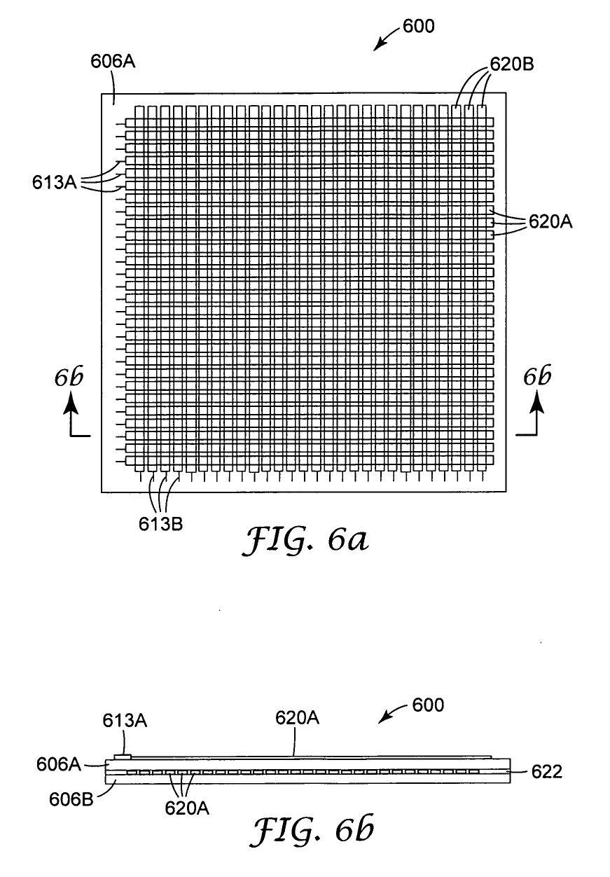

Sensors useful in the present invention include those disclosed in US 2005/0083307, which is incorporated by reference herein. Suitable sensors include a plurality of resistive or conductive elements, for example in the form of traces or wires, arranged across an active area of the sensor. An exemplary matrix-type sensor is shown schematically in FIGS. 6(a) and 6(b). FIG. 6(a) shows a sensor 600 that includes a plurality of sensor bars 620A oriented in one direction and disposed on top of substrate 606A, and another plurality of sensor bars 620B oriented in the orthogonal direction and disposed on the bottom of substrate 606A. A series of leads 613A connects to at least one end of bars 620A, and series of leads 613B connects to at least one end of bars 620B. FIG. 6(b) shows a cross-section of sensor 600 taken along line 6b-6b. In the particular embodiment shown, sensor bars 620B are disposed on a second substrate 606B, which is laminated to substrate 606A via an adhesive 622 such as an optical adhesive. In alternative embodiments, sensor bars 620B can be patterned onto the back side of substrate 606A. The sensor 600 can be laminated to a rigid substrate such as glass, or can be laminated directly to a display surface or otherwise disposed over a suitable surface.

Exemplary applications where it is desirable to integrate sensors and electronics, and for which methods and materials of the present invention may be preferred include those disclosed in US 2004/0155871, US 2004/0095333, and US 2005/0083307, which documents have been previously incorporated by reference.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the instant specification.

What is claimed is:

1. A touch sensor assembly comprising:
a touch sensor overlay comprising a plurality of touch sensitive elements and a plurality of conductors connected to the touch sensitive elements arranged on the touch sensor periphery; and
a frame subassembly affixed to the touch sensor periphery, the frame subassembly comprising a frame and one or more circuit boards held in place by the frame, the one or more circuit boards electrically connected to the plurality of conductors,
wherein the circuit boards include circuitry for conditioning signals communicated by the touch sensitive elements due to a touch on the touch sensor overlay.

2. The touch sensor assembly of claim 1, wherein the touch sensor overlay comprises one or more flexible films laminated to a rigid substrate, the plurality of touch sensitive elements and the plurality of conductors being formed on the flexible film.

3. The touch sensor assembly of claim 2, wherein the frame has a coefficient of thermal expansion that falls within a range bounded by the coefficients of thermal expansion of the one or more flexible films and the rigid substrate.

4. The touch sensor assembly of claim 1, wherein the frame comprises a glass filled liquid crystal polymer or a glass filled polycarbonate.

5. The touch sensor assembly of claim 1, wherein frame subassembly is affixed to the touch sensor by a pressure sensitive adhesive, the pressure sensitive adhesive having apertures in each of which is placed a conductive material to electrically connect the one or more circuit boards to the plurality of conductors.

6. The touch sensor assembly of claim 1, wherein frame subassembly is affixed to the touch sensor by a z-axis conductive adhesive that functions to electrically connect the one or more circuit boards to the plurality of conductors.

7. The touch sensor assembly of claim 1, wherein the frame subassembly further comprises self-fixturing features.

8. The touch sensor assembly of claim 7, wherein the self-fixturing features include alignment tabs extending from the plane of the frame.

9. The touch sensor assembly of claim 7, wherein the self-fixturing features determine a spacing between one or more of the frame and a part of the touch sensor, the frame and the one or more circuit boards, and the one or more circuit boards and a part of the touch sensor.

10. A method of bonding electronics to a touch sensitive overlay comprising the steps of:
providing a touch sensor comprising a plurality of touch sensitive elements and a plurality of conductors connected to the touch sensitive elements arranged on the touch sensor periphery;
providing one or more circuit boards that include circuitry for conditioning signals communicated by the touch sensitive elements due to a touch on the touch sensor, each circuit board having a plurality of conductive contact areas;
dispensing an insulative adhesive on the touch sensor periphery and forming apertures in the adhesive to individually expose the plurality of conductors on the touch sensor;
placing a conductive material on the plurality of conductors; and
positioning the one or more circuit boards on the touch sensor periphery so that the conductive material electrically connects each of the conductive contact areas to one of the plurality of conductors, and the adhesive bonds the circuit board to the touch sensor.

11. The method of claim 10, further comprising using a frame to aid in the positioning of the one or more circuit boards.

12. The method of claim 11, further comprising providing self-fixturing features on the frame to control a spacing of one or more of:
a. the one or more circuit boards and a part of the touch sensor;
b. the frame and part of the touch sensor; and
c. the frame and the one or more circuit boards.

13. The method of claim 11, wherein the frame has a coefficient of thermal expansion that closely matches the coefficient of thermal expansion of the touch sensor materials.

14. The method of claim 10, wherein the step of dispensing and forming apertures in the adhesive is performed prior to placing the conductive material on the plurality of conductors.

15. The method of claim 10, wherein the step of placing the conductive material on the plurality of conductors is performed prior to dispensing and forming apertures in the adhesive.

16. The method of claim 10, wherein the step of dispensing and forming apertures in the adhesive comprises forming the apertures in a pressure sensitive adhesive layer and adhering the pressure sensitive adhesive layer to the touch sensor periphery.
